(19) United States
(12) Patent Application Publication
(10) Pub. No.: US 2005/0144783 A1
(43) Pub. Date: Jul. 7, 2005

(54) Shearing device including ridges

(76) Inventor: Wai-Wah Yiu, Hong Kong (CN)

Correspondence Address: JONES DAY, 222 EAST 41ST ST, NEW YORK, NY, 10017, US

(21) Appl. No.: 10/748,037

(22) Filed: Dec. 29, 2003

(51) Int. Cl. B26B 19/00

(52) U.S. Cl. 30/29.5

(57) ABSTRACT

A shearing device is provided for, for example, trimming hair in the nose, that spaces the teeth on the blades of the device from the skin. The shearing device includes a housing having a top portion and a bottom portion, where the top portion has an opening and a plurality of ridges that form channels adjacent to the opening. At least one cutting blade is disposed in the opening in the top portion of the housing of the shearing device. The top portion of the shearing device includes ridges, and brackets the cutting teeth of the trimmer on either side and includes a plurality of ridges forming channels that expose the teeth on the trimmer blades. The length of the hairs remaining after cutting is determined by the depth of the channels.

### FIELD OF INVENTION

This invention relates to a shearing device with safety strips that space the blades of the device a distance from a surface to prevent damage to the surface during operation.

### BACKGROUND OF THE INVENTION

There are many varieties of compact electric facial trimmers available on the market for removal of facial hair. In many instances, the compact electric facial trimmers are sold with attachments that space the blades of the trimmer from the skin, and cause the facial hair to be safely trimmed to a desired length. Such attachments are typically shaped to presents a substantially flat surface to the skin and space the cutting teeth a desired distance from the skin. The attachments also typically include a plurality of fins that lift the facial hair strands, or whiskers, for trimming, while channels between the fins guide the hair to the blades of the shearing device. Some attachments are shaped to space the blade of the trimmer different distances from the skin to allow the facial hair to be safely cut to two different lengths as desired by the user.

Such known attachments are, however, not adapted for safe operation of the shearing device to trim hairs inside the nose. That is because they are designed for operation of the shearing device on substantially flat surfaces of the body, such as on the face, which are obviously quite different from the inside of the nose and are too bulky for comfortable operation in the nose. Additionally, any attempt to operate a shearing device as a nose hair trimmer without an attachment to serve as a safety guide could cause the blades to come dangerously close to the skin, resulting in cuts or abrasions, damage to the skin and, extreme discomfort. There is therefore a need for a streamlined shearing device that is adapted for safe operation inside the nose, and other places where conventional trimmers do not work well. Such a shearing device should present a rounded shape to the surface, while spacing the blades a safe distance from the surface, for comfortable and convenient trimming of hair within the nose.

An object of the present invention is to provide a shearing device which can be used for safely trimming hair without the blades coming in contact with the surface being trimmed.

Another object of this invention is to provide a shearing device which space the blades of the trimmer from the skin during operation for trimming hair inside the nose.

### SUMMARY OF THE INVENTION

A shearing device is provided which facilitates operation of the device without damaging the surface. In a preferred embodiment, the shearing device includes a housing having a top portion and a bottom portion, the top portion having an opening and a plurality of ridges forming channels adjacent to the opening; at least one blade disposed in the opening in the top portion of the housing; and driving means located within said housing operatively connected to said at least one blade. The opening in the housing provides access for the blades to cut the hair. The opening can be of any shape, but is preferably oval, oblong, or rectangular. The ridges serve to separate the blades from the skin. Preferably, the ridges are made of plastic. The cross-sectional shape of the ridges can be square, rectangular, triangular, circular, oval, or oblong. The blades of the shearing device are formed with a plurality of teeth, which are reciprocated to shear the hair. The blade can be reciprocated by many different driving means, including a motor, gears, a battery, AC connection or manual power.

### BRIEF DESCRIPTION OF THE DRAWINGS

FIG. 1 is a view of a shearing device including a top portion including blades for use as a shearing device according to the invention;

FIGS. 2A-D show rotated side views of the shearing device of FIG. 1 according to the present invention;

FIGS. 3A-D are views of the cutting head of the shearing device.

### DESCRIPTION OF THE PREFERRED EMBODIMENTS

The present invention has been described in terms of a shearing device that provides for safely spacing the blades away from a surface, and that allows operation of the device as, e.g., a nose hair trimmer. While the invention is described in terms of use for shearing hair inside the nose, there are many possible uses of the device or modification of the device that may be apparent to one of ordinary skill in the art. For example, the device can be used for shearing hair, such as from the face or ears or modified for use to remove lint and other debris from garments, or any other type of material from a surface.

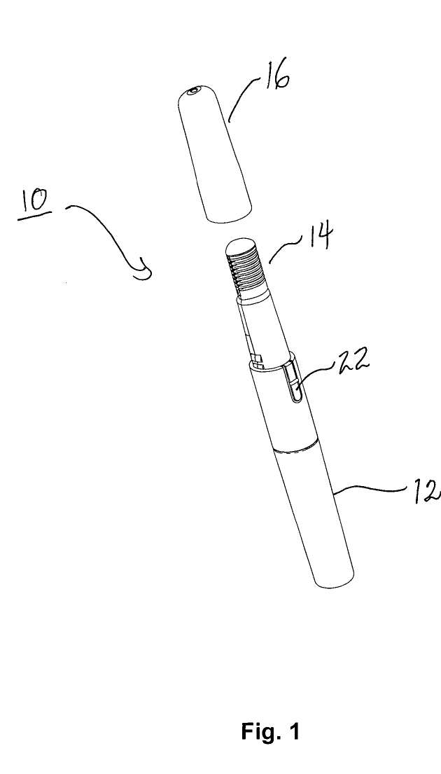

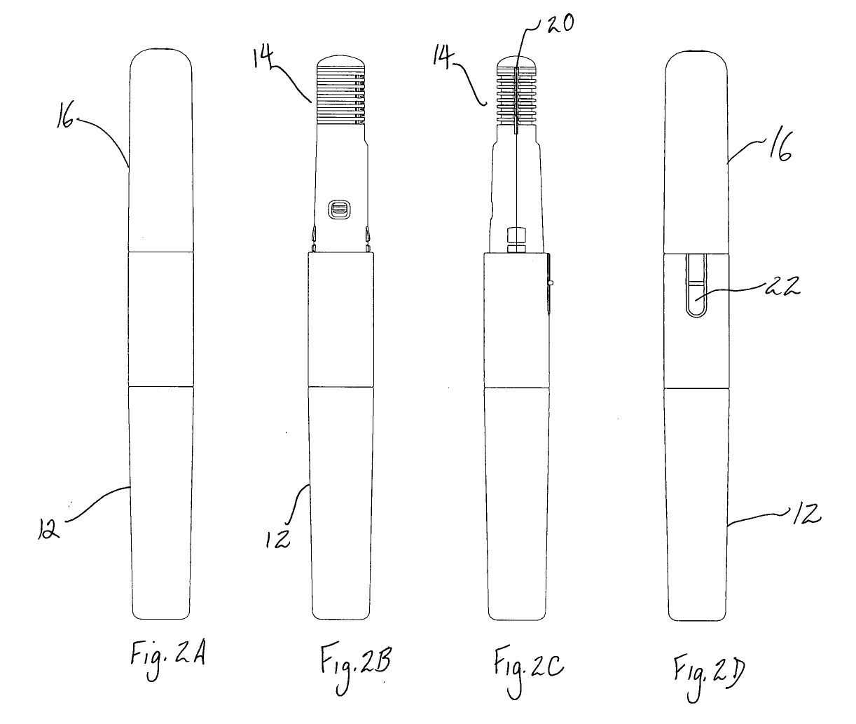

As shown in FIGS. 1 and 2A-D, the shearing device 10 has a housing having a longitudinal axis and includes a handle 12, cutting head 14, capping member 16, and ON/OFF switch 22. The cutting head 14 located at the top portion of the housing, includes cutting blades 20, which are oriented along the cutting head's longitudinal axis. The capping member 16 may be positioned over the cutting head 14. Handle 12 is located at the bottom portion of the housing. ON/OFF switch 22 turns the device and off.

FIGS. 2A-D show rotated views of the shearing device 10. FIGS. 2A and 2D show the shearing device including capping member 16, while in FIGS. 2B and 2C capping member 16 is absent.

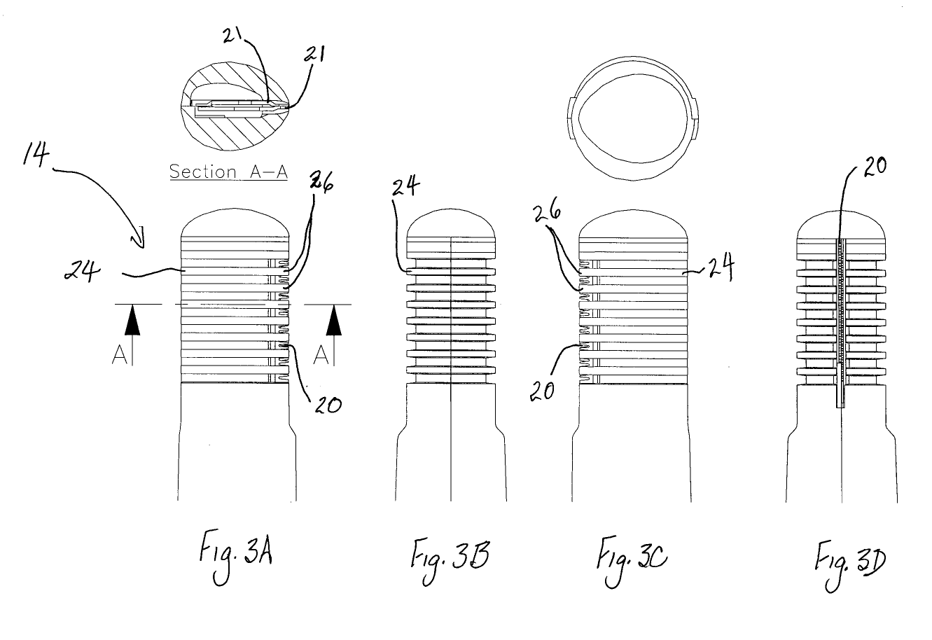

FIGS. 3A-3D illustrate the cutting head 14 of the shearing device 10. FIG. 3D shows the cutting head 14 including cutting blades 20 oriented along the longitudinal axis of the cutting head 14. The cutting blades 20 include at least one blade positioned within the housing. In one embodiment of the invention, cutting blades 20 include at least two blades 27 and 28. In this embodiment at least one blade member can be stationary, while the other blade can move in a reciprocating fashion. In another embodiment, the two blades are both capable of moving in a reciprocating fashion relative to one another. The moving blade or blades are connected to driving means (not shown) located within the housing, capable of causing the blades to move in a fashion reciprocating relative to each other or the housing. Means for driving the blades is well known and will not be described here. The driving means can be electrically powered, including motors, gears, batteries and/or AC connectivity or can be manually powered.

Each blade 27 and 28 is formed with a plurality of teeth. The reciprocating motion of the blade members causes the teeth of adjacent blades to cross back and forth, which provides for the shearing of, e.g., hair. When a hair strand enters the area of the cutting blades 20, the teeth of the one or more reciprocating blades pass across the spaces between the teeth of another blade 20, engaging the hair strand and shearing it.

A plurality of ridges 26 and opening 29 in cutting head 14 form a plurality of channels that serve to expose the teeth of the cutting blades 20. The ridges 26 extend to opening 29 centered around the cutting blades 20, and bracket the teeth of the cutting blades 20 on either side. In one embodiment, the opening runs the entire length of the cutting blades 20. In the exemplary embodiment of FIGS. 3A and 3C, the width of the channels are such that a number of the teeth of the cutting blades 20 are exposed during operation to cut hair. Opening 29 around the blades 20 can be rectangular, oval, oblong, or other shapes.

The ridges 26 also serve to space the blades of the shearing device a safe distance from the surface, which is beneficial during operation of the device for removing hair from sensitive areas, e.g., from within the nose. The ridges 26 significantly reduces the risk of cutting or abrading skin, effectively eliminating the risk of damage or discomfort. The length of the hairs remaining after shearing is determined primarily by the depth of the ridges 26 adjacent the opening. For example, the hairs can be trimmed to relatively long lengths if ridges 26 adjacent the opening are relatively deep. If the ridges 26 adjacent the opening are made shallower, the hair can be trimmed to relatively short lengths. The optimal thickness of the ridges 26 in the region of the opening depends on various factors, such as the minimal desired safe distance maintained between the blades and the skin, the length the teeth of the blades, the desired length of the trimmed hair, and the strength of the material forming the ridges 26. Desired lengths of trimmed hairs in the nose are typically between 0.020 inches and 0.040 inches, although other thicknesses between about 0.010 inches and 0.125 inches are contemplated and the invention is not limited by the length of the trimmed hair. In one embodiment, the depth of the ridges 26 in the region of the opening is approximately the length of the teeth of the blades 20. In other embodiments, the depth of the channels between ridges is also the length of the teeth of the blades 20.

In the exemplary embodiment of FIGS. 3A-D, the ridges 26 extend about the circumference to become ridges 24 on an opposite face of the cutting head 14. In other embodiments, the ridges 26 are formed only near the opening, and the surface of the cutting head away from the opening is substantially smooth, i.e., ridges 24 are absent. In the different embodiments of the invention, the extent of the indentations formed by ridges 26 about the cutting head 14 varies according to the choice of design. The ridges can have many different cross-sectional shapes, such as square, rectangular, triangular, circular, oval, oblong, or other shapes. Additionally, while the ridges 24 or 26 are illustrated in FIGS. 3A-D as running at an angle of 90° to the longitudinal axis of the housing, i.e., in a circular pattern, in other embodiments the ridges can be oriented at other angles to the housing. For example the ridges can be patterned in a “V” shape relative to said opening. In another embodiment, ridges 24 or 26 are oriented on a helical pattern relative to the housing.

In many embodiments, the ridges 24 and 26 are formed integral with, and are non-removable from the top portion of the housing of the shearing device. However, in other embodiments, the ridges 24 and 26 may be formed on a body which serves as a removable attachment to a shearing device in which the blades are otherwise unprotected. Such a removable attachment could slips over the cutting head 14 of the shearing device 10 and can be secured to the trimmer by means known in the art.

In one embodiment, the ridges 24 and 26 are formed of a smooth, resilient material, such as a plastic. Such a material would presents little or no friction to the skin, which would significantly reduce or prevents any pulling on the skin. In embodiments of the shearing device including a removable attachment, the attachment is formed from a pliable material for easy placement over the cutting blades 20. In embodiments where the ridges 26 are fixed to the cutting head 14, the material may be less pliable, such that the ridges 26 and channels are fairly sturdy and do not bend or break easily.

The shearing device 10 of the present invention can be operated in any manner desired by the user. For example, the rounded smooth head of the shearing device illustrated in FIGS. 1-3D allows for operation as a nose hair trimmer. In operation, one or more of the cutting blades 20 is reciprocated relative to each other or the housing while the shearing device 10 is brought in contact with the hair within the nose. The shearing device can be rotated during operation. As the ridges 26 serve to safely space the cutting blades 20 away from the skin, the cutting head 14 of the shearing device 10 can also be brought in direct contact with the skin during operation.

Applications of the present invention include for example safe trimming of hair from the skin of the face, ear, nose, neck or other portions of the body without risk of abrading or damaging the skin.

While the principles of the invention have been described above in connection with specific apparatus and applications, it is to be understood that this description is made only by way of example and not as a limitation on the scope of the invention.

1. An shearing device, comprising:
a housing having a top portion and a bottom portion, the top portion having an opening and a plurality of ridges forming channels adjacent to the opening;
at least one blade disposed in the opening in the top portion of the housing; and
driving means located within said housing operatively connected to said at least one blade.

2. The shearing device of claim 1, wherein said ridges are made of plastic.

3. The shearing device of claim 1, wherein said at least one blade comprises a plurality of teeth.

4. The shearing device of claim 3, wherein the depth of the channels formed by the ridges is the length of the teeth of at least one blade.

5. The shearing device of claim 3, wherein the depth of the channels formed by the ridges is greater than the length of the teeth of at least one blade.

6. The shearing device of claim 3, wherein the depth of the channels formed by the ridges is less than the length of the teeth of at least one blade.

7. The shearing device of claim 1, wherein said opening is one of oval, oblong, or rectangular.

8. The shearing device of claim 1, wherein a cross-sectional shape of said ridges is one of square, rectangular, triangular, circular, oval, or oblong.

9. The shearing device of claim 1, wherein said ridges are oriented at an angle of 90° to a longitudinal axis of the housing.

10. The shearing device of claim 1, wherein said ridges are oriented at an angle of other than 90° to a longitudinal axis of the housing.

11. The shearing device of claim 1, wherein said ridges form a helical pattern around said housing.

12. The shearing device of claim 1, wherein said ridges form a “V” shape relative to said opening.

13. The shearing device of claim 1, wherein said driving means is electrically powered.

14. The shearing device of claim 1, wherein said driving means is a motor, gears, a battery or AC connection.

15. The shearing device of claim 1, wherein said driving means is manual power.
